(19) United States
(12) Patent Application Publication
(10) Pub. No.: US 2026/0303184 A1
(43) Pub. Date: Oct. 1, 2026

(54) ANTENNA IDENTIFICATION FOR NETWORK DEVICES

(71) Applicant: Juniper Networks, Inc., Sunnyvale, CA (US)

(72) Inventors: Clark Alan Carty, Brunswick, OH (US); John James Musante, Holtsville, NY (US); James Jay Friedmann, Canton, OH (US); Joshua Rosenthal, San Jose, CA (US)

(21) Appl. No.: 19/094,352

(22) Filed: Mar. 28, 2025

(51) Int. Cl. H04B 7/06

(52) U.S. Cl. CPC H04B 7/06952

(57) ABSTRACT

Techniques are described for a system including a network management system; and a device connected to an antenna, wherein the device is configured to: determine an electrical parameter value associated with the antenna, send the electrical parameter value to the network management system, wherein the network management system is configured to: determine, based on the electrical parameter value, an identifier of the antenna, determine, based on the identifier of the antenna, one or more operational parameters for the antenna, and send, to the device, the one or more operational parameter to control operation of the antenna, and wherein the device is further configured to control an operation of the antenna based on the one or more operational parameters.

### TECHNICAL FIELD

The disclosure relates generally to computer networks and, more specifically, to management of computer networks.

### BACKGROUND

Commercial premises or sites, such as offices, hospitals, airports, stadiums, or retail outlets, often install complex wireless network systems, including a network of wireless access points (APs), throughout the premises to provide wireless network services to one or more wireless client devices (or simply, “clients”). APs are physical, electronic devices that enable other devices to wirelessly connect to a wired network using various wireless networking protocols and technologies, such as wireless local area networking protocols conforming to one or more of the IEEE 802.11 standards (i.e., “WiFi”), Bluetooth/Bluetooth Low Energy (BLE), mesh networking protocols such as ZigBee or other wireless networking technologies. Many different types of wireless client devices, such as laptop computers, smartphones, tablets, wearable devices, appliances, and Internet of Things (IoT) devices, incorporate wireless communication technology and can be configured to connect to wireless access points when the device is in range of a compatible wireless access point in order to access a wired network. In the case of a client device running a cloud-based application, such as voice over Internet Protocol (VoIP) applications, streaming video applications, gaming applications, or video conference applications, data is exchanged during an application session from the client device through one or more APs and one or more wired network devices, e.g., switches, routers, and/or gateway devices, to reach the cloud-based application server.

One or more antennas of a network device may be configured to operate according to one or more operational parameters defined by a regulatory body, such as Federal Communications Commission (FCC), European Conformity (CE), or other regulatory bodies. In some examples, a regulatory body may specify Effective Isotropic Radiated Power (EIRP) regulations that specify, for example, power limits for corresponding frequency bands provided by the antennas.

### SUMMARY

In general, this disclosure describes one or more techniques for determining antenna information to control operation of an antenna connected to a network device. Network devices may include a measurement circuit configured to determine an electrical parameter value associated with one or more circuit elements of an antenna. For example, responsive to an antenna being connected to a network device, the network device may detect a load and initiate a signal (e.g., by applying a voltage) for the measurement circuit (e.g., a current measurement circuit) to determine a electrical parameter value associated with one or more circuit elements of the antenna, such as a determining resistance value of a circuit element, impedance value of a circuit element, current value through a circuit element, etc. In some examples, the network device may send the electrical parameter value associated with one or more circuit elements of the antenna to a network management system (NMS), which in turn may determine, based on the electrical parameter value, an identifier of the antenna (e.g., part number, serial number, manufacture date, etc.). Based on the determined identifier of the antenna, the NMS may determine one or more operational parameters for the antenna (e.g., antenna gain, transmission power limit, beamforming information, etc.) that may configure the antenna to comply with, for example, FCC regulations. The NMS may send the operational parameters to the network device, which in turn may control operation of the antenna based on the operational parameters. For instance, the network device may configure the antenna to operate in accordance with the operational parameters (e.g., configure antenna gain parameters, transmission control parameters, beamforming parameters, channel selection parameters, band selection parameters, etc.).

Alternatively, or additionally, the network device may determine an identifier of the antenna based on the electrical parameter value associated with one or more circuit elements of the antenna and send the identifier of the antenna to the NMS, which in turn may determine and send one or more operational parameters for the antenna.

The techniques of this disclosure provide one or more technical advantages and practical applications. By automatically determining an identity of an antenna based on an electrical parameter value associated with one or more circuit elements of the antenna, the NMS may quickly and efficiently determine operational parameters for the antenna that comply with regulatory standards, such as transmission power requirements, while reducing errors that may occur when manually configuring settings for the antenna (e.g., manually entering incorrect antenna identification information may result in applying incorrect operational parameters for the antenna). Moreover, by using measurement circuit of a network device to measure the electrical parameter value associated with one or more circuit elements of the antenna to identify the antenna, the process to configure operational parameters for the antenna to comply with regulatory standards is less resource intensive and/or less costly than using computationally intensive memory components, such as an EEPROM.

In one example, the disclosure is directed to a network management system including memory and processing circuitry coupled to the memory. The processing circuitry may be configured to obtain an electrical parameter value associated with one or more circuit elements of an antenna connected to a device. The processing circuitry may further be configured to determine, based on the electrical parameter value, an identifier of the antenna. The processing circuitry may further be configured to determine, based on the identifier of the antenna, one or more operational parameters for the antenna. The processing circuitry may further be configured to send the one or more operational parameters to the device to control operation of the antenna.

In another example, the disclosure is directed to computer-readable storage media comprising instructions that, when executed, cause processing circuitry to obtain an electrical parameter value associated with one or more circuit elements of an antenna connected to a device. The instructions may further cause the processing circuitry may further be configured to determine, based on the electrical parameter value, an identifier of the antenna. The instructions may further cause the processing circuitry may further be configured to determine, based on the identifier of the antenna, one or more operational parameters for the antenna. The instructions may further cause the processing circuitry may further be configured to send the one or more operational parameters to the device to control operation of the antenna.

In another example, the disclosure is directed to a method comprising obtaining, by a network management system, an electrical parameter value associated with one or more circuit elements of an antenna connected to a device. The method may further include determining, by the network management system and based on the electrical parameter value, an identifier of the antenna. The method may further include determining, by the network management system and based on the identifier of the antenna, one or more operational parameters for the antenna. The method may further include sending, by the network management system, the one or more operational parameters to the device to control operation of the antenna.

In yet another example, the disclosure is directed to a network device comprising processing circuitry configured to determine an electrical parameter value associated with one or more circuit elements of an antenna connected to the network device. The processing circuitry may further be configured to send the electrical parameter value to a network management system. The processing circuitry may further be configured to receive, from the network management system, one or more operational parameters for the antenna. The processing circuitry may further be configured to control an operation of the antenna based on the one or more operational parameters for the antenna.

In another example, the disclosure is directed to computer-readable storage media comprising instructions that, when executed, cause processing circuitry to determine an electrical parameter value associated with one or more circuit elements of an antenna connected to the network device. The instructions may further cause the processing circuitry may further be configured to send the electrical parameter value to a network management system. The instructions may further cause the processing circuitry may further be configured to receive, from the network management system, one or more operational parameters for the antenna. The instructions may further cause the processing circuitry may further be configured to control an operation of the antenna based on the one or more operational parameters for the antenna.

In another example, the disclosure is directed to a method comprising determining, by a network device, an electrical parameter value associated with one or more circuit elements of an antenna connected to the network device. The method may further include sending, by the network device, the electrical parameter value to a network management system. The method may further include receiving, by the network device and from the network management system, based on sending the electrical parameter value to the network management system, one or more operational parameters for the antenna. The method may further include controlling, by the network device, an operation of the antenna based on the one or more operational parameters for the antenna.

In yet another example, the disclosure is directed to a system comprising a network management system and a device connected to an antenna. The device may be configured to determine an electrical parameter value associated with the antenna. The device may further be configured to send the electrical parameter value to the network management system. The network management system may be configured to determine, based on the electrical parameter value, an identifier of the antenna. The network management system may further be configured to determined, based on the identifier of the antenna, one or more operational parameters for the antenna. The network management system may further be configured to send, to the device, the one or more operational parameters to control operation of the antenna. The device may be further configured to control an operation of the antenna based on the one or more operational parameters.

In another example, the disclosure is directed to computer-readable storage media comprising instructions that, when executed, cause processing circuitry to determine an electrical parameter value associated with an antenna connected to a device. The processing circuitry may further be configured to send the electrical parameter value to a network management system. The processing circuitry may further be configured to determine, based on the electrical parameter value, an identifier of the antenna. The processing circuitry may further be configured to determine, based on the identifier of the antenna, one or more operational parameters for the antenna. The processing circuitry may further be configured to send, to the device, the one or more operational parameters to control operation of the antenna. The processing circuitry may further be configured to control an operation of the antenna based on the one or more operational parameters.

In another example, the disclosure is directed to a method comprising determining, by a device connected to an antenna, an electrical parameter value associated with the antenna. The method may further include sending, by the device, the electrical parameter value to a network management system. The method may further include determining, by the network management system and based on the electrical parameter value, an identifier of the antenna. The method may further include determining, by the network management system and based on the identifier of the antenna, one or more operational parameters for the antenna. The method may further include sending, by the network management system to the device, the one or more operational parameters to control operation of the antenna. The method may further include controlling, by the device, operation of the antenna based on the one or more operational parameters.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1A is a block diagram of an example network system configured to determine antenna information to control operation of an antenna connected to a network device, in accordance with one or more techniques of the disclosure.

FIG. 1B is a block diagram illustrating further example details of the network system of FIG. 1A.

FIG. 2 is a block diagram of an example access point device, in accordance with one or more techniques of this disclosure.

FIG. 3 is a block diagram of an example network management system, in accordance with one or more techniques of the disclosure.

FIG. 4 is a block diagram of an example user equipment device, in accordance with one or more techniques of this disclosure.

FIG. 5 is a block diagram of an example network device, such as a router or switch, in accordance with one or more techniques of this disclosure.

FIG. 6 is a flow chart illustrating an example operation of a system including an example network device and an example network management system, in accordance with one or more techniques of this disclosure.

FIG. 7 is a flow chart illustrating an example operation of a network management system, in accordance with one or more techniques of this disclosure.

FIG. 8 is a flow chart illustrating an example operation of a network device, in accordance with one or more techniques of this disclosure.

### DETAILED DESCRIPTION

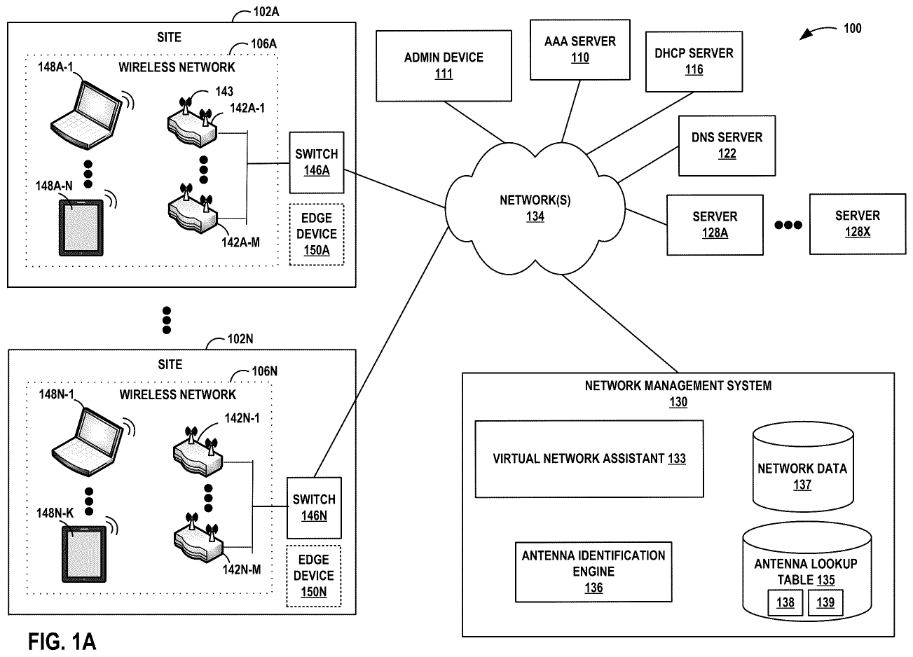

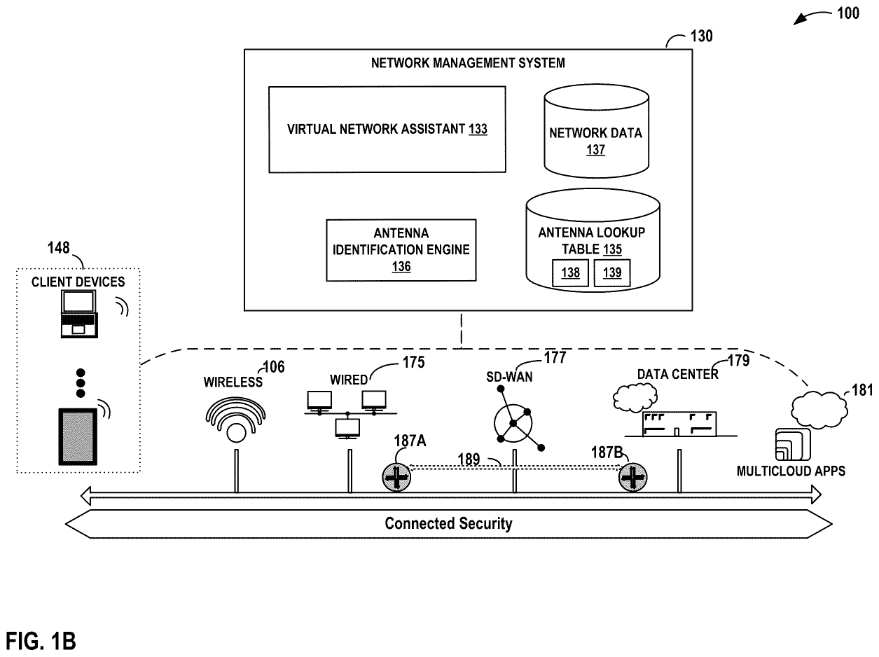

FIG. 1A is a block diagram of an example network system 100 configured to determine antenna information to control operation of an antenna connected to a network device, in accordance with one or more techniques of this disclosure. Example network system 100 includes a plurality sites 102A-102N at which a network service provider manages one or more wireless networks 106A-106N, respectively. Although in FIG. 1A each site 102A-102N is shown as including a single wireless network 106A-106N, respectively, in some examples, each site 102A-102N may include multiple wireless networks, and the disclosure is not limited in this respect.

Each site 102A-102N includes a plurality of network access server (NAS) devices, such as access points (APs) 142, switches 146, or routers (not shown). For example, site 102A includes a plurality of APs 142A-1 through 142A-M. Similarly, site 102N includes a plurality of APs 142N-1 through 142N-M. Each AP 142 may be any type of wireless access point, including, but not limited to, a commercial or enterprise AP, a router, or any other device that is connected to a wired network and is capable of providing wireless network access to client devices within the site. Each AP 142 may include one or more antennas configured to transmit one or more wireless signals into one of sites 102A-102N.

Each site 102A-102N also includes a plurality of client devices, otherwise known as user equipment devices (UEs), referred to generally as UEs or client devices 148, representing various wireless-enabled devices within each site. For example, a plurality of UEs 148A-1 through 148A-K are currently located at site 102A. Similarly, a plurality of UEs 148N-1 through 148N-K are currently located at site 102N. Each UE 148 may be any type of wireless client device, including, but not limited to, a mobile device such as a smart phone, tablet or laptop computer, a personal digital assistant (PDA), a wireless terminal, a smart watch, smart ring, or other wearable device. UEs 148 may also include wired client-side devices, e.g., IoT devices such as printers, security devices, environmental sensors, or any other device connected to the wired network and configured to communicate over one or more wireless networks 106.

In order to provide wireless network services to UEs 148 and/or communicate over the wireless networks 106, APs 142 and the other wired client-side devices at sites 102 are connected, either directly or indirectly, to one or more network devices (e.g., switches, routers, or the like) via physical cables, e.g., Ethernet cables. In the example of FIG. 1A, site 102A includes a switch 146A to which each of APs 142A-1 through 142A-M at site 102A are connected. Similarly, site 102N includes a switch 146N to which each of APs 142N-1 through 142N-M at site 102N are connected. Although illustrated in FIG. 1A as if each site 102 includes a single switch 146 and all APs 142 of the given site 102 are connected to the single switch 146, in other examples, each site 102 may include more or fewer switches and/or routers. In addition, the APs and the other wired client-side devices of the given site may be connected to two or more switches and/or routers. In addition, two or more switches at a site may be connected to each other and/or connected to two or more routers, e.g., via a mesh or partial mesh topology in a hub-and-spoke architecture. In some examples, interconnected switches and routers comprise wired local area networks (LANs) at sites 102 hosting wireless networks 106.

Example network system 100 also includes various networking components for providing networking services within the wired network including, as examples, an Authentication, Authorization and Accounting (AAA) server 110 for authenticating users and/or UEs 148, a Dynamic Host Configuration Protocol (DHCP) server 116 for dynamically assigning network addresses (e.g., IP addresses) to UEs 148 upon authentication, a Domain Name System (DNS) server 122 for resolving domain names into network addresses, a plurality of servers 128A-128X (collectively “servers 128”) (e.g., web servers, databases servers, file servers and the like), and a network management system (NMS) 130. As shown in FIG. 1A, the various devices and systems of network 100 are coupled together via one or more network(s) 134, e.g., the Internet and/or an enterprise intranet.

In the example of FIG. 1A, network management system (NMS) 130 is a cloud-based computing platform that manages wireless networks 106A-106N at one or more of sites 102A-102N. As further described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. In some examples, NMS 130 outputs notifications, such as alerts, alarms, graphical indicators on dashboards, log messages, text/SMS messages, email messages, and the like, and/or recommendations regarding wireless network issues to a site or network administrator (“admin”) interacting with and/or operating admin device 111. Additionally, in some examples, NMS 130 operates in response to configuration input received from the administrator interacting with and/or operating admin device 111.

The administrator and admin device 111 may comprise IT personnel and an administrator computing device associated with one or more of sites 102. Admin device 111 may be implemented as any suitable device for presenting output and/or accepting user input. For instance, admin device 111 may include a display. Admin device 111 may be a computing system, such as a mobile or non-mobile computing device operated by a user and/or by the administrator. Admin device 111 may, for example, represent a workstation, a laptop or notebook computer, a desktop computer, a tablet computer, or any other computing device that may be operated by a user and/or present a user interface in accordance with one or more aspects of the present disclosure. Admin device 111 may be physically separate from and/or in a different location than NMS 130 such that admin device 111 may communicate with NMS 130 via network 134 or other means of communication.

In some examples, one or more of the NAS devices, e.g., APs 142, switches 146, or routers, may connect to edge devices 150A-150N via physical cables, e.g., Ethernet cables. Edge devices 150 comprise cloud-managed, wireless local area network (LAN) controllers. Each of edge devices 150 may comprise an on-premises device at a site 102 that is in communication with NMS 130 to extend certain microservices from NMS 130 to the on-premises NAS devices while using NMS 130 and its distributed software architecture for scalable and resilient operations, management, troubleshooting, and analytics.

Each one of the network devices of network system 100, e.g., servers 110, 116, 122 and/or 128, APs 142, UEs 148, switches 146, and any other servers or devices attached to or forming part of network system 100, may include a system log or an error log module wherein each one of these network devices records the status of the network device including normal operational status and error conditions. Throughout this disclosure, one or more of the network devices of network system 100, e.g., servers 110, 116, 122 and/or 128, APs 142, UEs 148, and switches 146, may be considered “third-party” network devices when owned by and/or associated with a different entity than NMS 130 such that NMS 130 does not receive, collect, or otherwise have access to the recorded status and other data of the third-party network devices. In some examples, edge devices 150 may provide a proxy through which the recorded status and other data of the third-party network devices may be reported to NMS 130.

In some examples, NMS 130 monitors network data 137, e.g., one or more service level expectation (SLE) metrics, received from wireless networks 106A-106N at each site 102A-102N, respectively, and manages network resources, such as APs 142 at each site, to deliver a high-quality wireless experience to end users, IoT devices and clients at the site. For example, NMS 130 may include a virtual network assistant (VNA) 133 that implements an event processing platform for providing real-time insights and simplified troubleshooting for IT operations, and that automatically takes corrective action or provides recommendations to proactively address wireless network issues. VNA 133 may, for example, include an event processing platform configured to process hundreds or thousands of concurrent streams of network data 137 from sensors and/or agents associated with APs 142 and/or nodes within network 134. For example, VNA 133 of NMS 130 may include an underlying analytics and network error identification engine and alerting system in accordance with various examples described herein. The underlying analytics engine of VNA 133 may apply historical data and models to the inbound event streams to compute assertions, such as identified anomalies or predicted occurrences of events constituting network error conditions. Further, VNA 133 may provide real-time alerting and reporting to notify a site or network administrator via admin device 111 of any predicted events, anomalies, trends, and may perform root cause analysis and automated or assisted error remediation. In some examples, VNA 133 of NMS 130 may apply machine learning techniques to identify the root cause of error conditions detected or predicted from the streams of network data 137. If the root cause may be automatically resolved, VNA 133 may invoke one or more corrective actions to correct the root cause of the error condition, thus automatically improving the underlying SLE metrics and also automatically improving the user experience.

Further example details of operations implemented by the VNA 133 of NMS 130 are described in U.S. Pat. No. 9,832,082, issued Nov. 28, 2017, and entitled “Monitoring Wireless Access Point Events,” U.S. Publication No. US 2021/0306201, published Sep. 30, 2021, and entitled “Network System Fault Resolution Using a Machine Learning Model,” U.S. Pat. No. 10,985,969, issued Apr. 20, 2021, and entitled “Systems and Methods for a Virtual Network Assistant,” U.S. Pat. No. 10,958,585, issued Mar. 23, 2021, and entitled “Methods and Apparatus for Facilitating Fault Detection and/or Predictive Fault Detection,” U.S. Pat. No. 10,958,537, issued Mar. 23, 2021, and entitled “Method for Spatio-Temporal Modeling,” and U.S. Pat. No. 10,862,742, issued Dec. 8, 2020, and entitled “Method for Conveying AP Error Codes Over BLE Advertisements,” all of which are incorporated herein by reference in their entirety.

In operation, NMS 130 observes, collects and/or receives network data 137, which may take the form of data extracted from messages, counters, and statistics, for example. In accordance with one specific implementation, a computing device is part of NMS 130. In accordance with other implementations, NMS 130 may comprise one or more computing devices, dedicated servers, virtual machines, containers, services, or other forms of environments for performing the techniques described herein. Similarly, computational resources and components implementing VNA 133 may be part of the NMS 130, may execute on other servers or execution environments, or may be distributed to nodes within network 134 (e.g., routers, switches, controllers, gateways, and the like).

In general, one or more antennas of a network access server device (e.g., any of APs 142, switches 146, routers, etc.), referred to herein as simply “network device,” may be configured to operate according to one or more operational parameters defined by a regulatory body, such as Federal Communications Commission (FCC), European Conformity (CE), or other regulatory bodies. For example, a regulatory body may specify Effective Isotropic Radiated Power (EIRP) regulations that may, for example, specify power limits for respective frequency bands (e.g., low frequency (LF), medium frequency (MF), high frequency (HF), very high frequency (VHF), ultra-high frequency (UHF), Wi-Fi (e.g., 2.4 GHz, 5 GHz, 6 GHz), etc.) provided by the antennas.

Typically, an administrator may manually specify antenna settings for an antenna of the network device, such as an antenna gain, transmission power limit, beamforming settings (e.g., beam width), or other parameters associated with operation of the antenna to comply with the EIRP regulations. However, manually specifying antenna settings is prone to error and may cause the antenna settings for an antenna to violate regulatory standards, such as EIRP regulations. For example, an administrator may specify incorrect identification information of an antenna, which may cause a network management system to provide the antenna with incorrect operational parameters (e.g., antenna gains, transmission power limits, etc.) that may cause the antenna to violate power limits specified by EIRP regulations.

In accordance with one or more techniques of this disclosure, network system 100 may automatically identify an antenna connected to a network device based on an electrical parameter value associated with one or more circuit elements of the antenna to control operation of the antenna. For example, a network device (e.g., any of APs 142, switches 146, routers, etc.) may include a measurement circuit (e.g., a current circuit measurement) configured to determine an electrical parameter value associated with one or more circuit elements (e.g., one or more resistors with varying resistance values) of an antenna connected to the network device. As one example, AP 142A-1 may, responsive to connecting an antenna 143 to AP 142A-1, detect a load and initiate a signal (e.g., by applying a voltage) to generate a current to flow through a resistor embedded in antenna 143. The measurement circuit may determine a current value (milliamp) flowing through the resistor embedded in antenna 143 and/or determine, for example, a resistance value (ohms) of the resistor embedded in antenna 143.

As another example, AP 142A-1 may, additionally or alternatively, include a measurement circuit that may determine an electrical parameter value as a voltage associated with one or more circuit elements (e.g., one or more resistors) embedded in antenna 143. For instance, the measurement circuit of AP 142A-1 may detect a circuit element (e.g., resistor) of antenna 143 to create a “voltage divider” circuit (e.g., resistor of antenna 143 is in parallel with one of two resistors in series of the measurement circuit of AP 142A-1). AP 142A-1 may read the “voltage divider” circuit and determine an electrical parameter value associated with antenna 143 as a voltage of a resistor of the measurement circuit which is in parallel with a resistor of antenna 143. For example, in instances where the measurement circuit of AP 142A-1 does not detect a change in a voltage (e.g., 5 volts) associated with a voltage divider circuit, then no antenna is detected (e.g., no antenna connected, defective antenna, open cable, etc.). In instances where the measurement circuit detects a significant voltage drop (e.g., to 0.5 volts which may be set as a minimum electrical parameter value) associated with the voltage divider circuit, AP 142A-1 may determine a connected antenna has a short circuit or is otherwise defective. In such examples, electrical parameter values of voltage divider readings (e.g., 1 volt, 1.5 volts, 2.0 volts, 2.5 volts, etc.) may correspond to different antenna identifiers, antenna gains, or other identifying information for antennas.

Antenna identification engine 136 of NMS 130 may obtain the electrical parameter value, e.g., resistor value of the resistor embedded in antenna 143, and may determine information identifying antenna 143, such as an antenna part number, an antenna serial number, an antenna manufacture date, or other identifying information associated with antenna 143 connected to AP 142A-1. For example, antenna identification engine 136 may perform a lookup using the electrical parameter value to search antenna lookup table 135 that may index information identifying antenna 143 (e.g., part number, serial number, manufacture date, etc.), illustrated as antenna identifying information 138 in FIG. 1A, based on keys indicating electrical parameter values.

Based on the information identifying antenna 143 (e.g., based on data of identifying information 138 associated with a detected electrical parameter value), antenna identification engine 136 may determine one or more operational parameters for antenna 143. For example, antenna lookup table 135 may include mappings (e.g., indexed using electrical parameter values) of antenna identifying information 138 to one or more operational parameters 139, such as antenna gain information, transmit power information, beamforming information, etc. Although antenna lookup table 135 is illustrated as a part of network management system 130, antenna lookup table 135 may be stored in any other component of environment 100, such as any of APs 142, switches 146, servers 128, or the like.

NMS 130 may send the one or more operational parameters for antenna 143 to AP 142A-1 such that AP 142A-1 may configure and/or control operation of antenna 143 based on the operational parameters. For instance, AP 142A-1 may receive, from NMS 130, the one or more operational parameters for antenna 143 and may configure and/or control operation of antenna 143 by executing configuration instructions to configure one or more antenna settings of antenna 143 (e.g., antenna gain control parameters, transmit power control parameters, beamforming control parameters, probe control parameters, polling control parameters, etc.) based on the one or more operational parameters mapped to or otherwise associated with the identifier of antenna 143. For instance, AP 142A-1 may control operation of antenna 143 to comply with regulatory transmission standards by, for example, operating antenna 143 with a transmit power according to an operational parameter mapped to identifying information of antenna 143 determined based on an electrical parameter value of antenna 143.

Additionally, or alternatively, network devices may determine identifying information for connected antennas. For example, AP 142A-1 may include portions of antenna look up table 135 indicating identifying information 138 associated with corresponding antennas mapped to electrical parameter values that are associated with corresponding antennas. AP 142A-1 may detect an electrical parameter value associated with antenna 143 (e.g., using a measurement circuit). AP 142A-1 may determine an identifier of antenna 143 based on the electrical parameter value detected for antenna 143 being mapped to the identifier in the portions of antenna lookup table 135 stored at AP 142A-1. AP 142A-1 may send the determined identifier of antenna 143 to NMS 130. NMS 130 may determine, based on the identifier of antenna 143 and mappings of operational parameters 139 to identifying information 138, one or more operational parameters associated with antenna 143. NMS 130 may send the one or more operational parameters to AP 142A-1 to control operation of antenna 143.

The techniques of this disclosure provide one or more technical advantages and practical applications. For example, by embedding a resistor or other circuit element to an antenna, the techniques described in this disclosure may determine an identifier of the antenna to control operation of the antenna, which is less computationally intensive and less costly than identifying an antenna based on information hard-coded within EPROM or EEPROM of the antenna, which may be computationally more intensive and/or more costly.

Additionally, or alternatively, the techniques described herein may mitigate errors when configuring an antenna of a network device to comply with regulatory standards. For example, rather than manually entering information identifying an antenna, which may be entered incorrectly and result in incorrect operational parameters provided to the antenna, the techniques described in the disclosure may automatically and accurately identify an antenna based on an electrical parameter value associated with one or more circuit elements of the antenna. In this way, the techniques described herein may enhance the technological field of network device management by, for example, improving control of network devices to comply with regulatory standards.

Although the techniques of the present disclosure are described in this example as performed by NMS 130, techniques described herein may be performed by any other computing device(s), system(s), and/or server(s), and that the disclosure is not limited in this respect. For example, one or more computing device(s) configured to execute the functionality of the techniques of this disclosure may reside in a dedicated server or be included in any other server in addition to or other than NMS 130, or may be distributed throughout network 100, and may or may not form a part of NMS 130.

FIG. 1B is a block diagram illustrating further example details of the network system of FIG. 1A. In this example, FIG. 1B illustrates NMS 130 configured to operate according to an artificial intelligence/machine-learning-based computing platform providing comprehensive automation, insight, and assurance (Wi-Fi Assurance, Wired Assurance and WAN assurance) spanning from “client,” e.g., user devices 148 connected to wireless network 106 and wired LAN 175 (far left of FIG. 1B), to “cloud,” e.g., cloud-based application services 181 that may be hosted by computing resources within data centers 179 (far right of FIG. 1B).

As described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. For example, network management system 130 may be configured to proactively monitor and adaptively configure network 100 so as to provide self-driving capabilities. Moreover, VNA 133 includes a natural language processing engine to provide AI-driven support and troubleshooting, anomaly detection, AI-driven location services, and AI-driven radio frequency (RF) optimization with reinforcement learning.

As illustrated in the example of FIG. 1B, AI-driven NMS 130 also provides configuration management, monitoring and automated oversight of software defined wide-area network (SD-WAN) 177, which operates as an intermediate network communicatively coupling wireless networks 106 and wired LANs 175 to data centers 179 and application services 181. In general, SD-WAN 177 provides seamless, secure, traffic-engineered connectivity between “spoke” routers 187A of wired networks 175 hosting wireless networks 106, such as branch or campus networks, to “hub” routers 187B further up the cloud stack toward cloud-based application services 181. SD-WAN 177 often operates and manages an overlay network on an underlying physical Wide-Area Network (WAN), which provides connectivity to geographically separate customer networks. In other words, SD-WAN 177 extends Software-Defined Networking (SDN) capabilities to a WAN and allows network(s) to decouple underlying physical network infrastructure from virtualized network infrastructure and applications such that the networks may be configured and managed in a flexible and scalable manner.

In some examples, underlying routers of SD-WAN 177 may implement a stateful, session-based routing scheme in which the routers 187A, 187B dynamically modify contents of original packet headers sourced by client devices 148 to steer traffic along selected paths, e.g., path 189, toward application services 181 without requiring use of tunnels and/or additional labels. In this way, routers 187A, 187B may be more efficient and scalable for large networks since the use of tunnel-less, session-based routing may enable routers 187A, 187B to achieve considerable network resources by obviating the need to perform encapsulation and decapsulation at tunnel endpoints. Moreover, in some examples, each router 187A, 187B may independently perform path selection and traffic engineering to control packet flows associated with each session without requiring use of a centralized SDN controller for path selection and label distribution. In some examples, routers 187A, 187B implement session-based routing as Secure Vector Routing (SVR), provided by Juniper Networks, Inc.

Additional information with respect to session-based routing and SVR is described in U.S. Pat. No. 9,729,439, entitled “COMPUTER NETWORK PACKET FLOW CONTROLLER,” and issued on Aug. 8, 2017; U.S. Pat. No. 9,729,682, entitled “NETWORK DEVICE AND METHOD FOR PROCESSING A SESSION USING A PACKET SIGNATURE,” and issued on Aug. 8, 2017; U.S. Pat. No. 9,762,485, entitled “NETWORK PACKET FLOW CONTROLLER WITH EXTENDED SESSION MANAGEMENT,” and issued on Sep. 12, 2017; U.S. Pat. No. 9,871,748, entitled “ROUTER WITH OPTIMIZED STATISTICAL FUNCTIONALITY,” and issued on Jan. 16, 2018; U.S. Pat. No. 9,985,883, entitled “NAME-BASED ROUTING SYSTEM AND METHOD,” and issued on May 29, 2018; U.S. Pat. No. 10,200,264, entitled “LINK STATUS MONITORING BASED ON PACKET LOSS DETECTION,” and issued on Feb. 5, 2019; U.S. Pat. No. 10,277,506, entitled “STATEFUL LOAD BALANCING IN A STATELESS NETWORK,” and issued on Apr. 30, 2019; U.S. Pat. No. 10,432,522, entitled “NETWORK PACKET FLOW CONTROLLER WITH EXTENDED SESSION MANAGEMENT,” and issued on Oct. 1, 2019; and U.S. Pat. No. 11,075,824, entitled “IN-LINE PERFORMANCE MONITORING,” and issued on Jul. 27, 2021, the entire content of each of which is incorporated herein by reference in its entirety.

In some examples, AI-driven NMS 130 may enable intent-based configuration and management of network system 100, including enabling construction, presentation, and execution of intent-driven workflows for configuring and managing devices associated with wireless networks 106, wired LAN networks 175, and/or SD-WAN 177. For example, declarative requirements express a desired configuration of network components without specifying an exact native device configuration and control flow. By utilizing declarative requirements, what should be accomplished may be specified rather than how it should be accomplished. Declarative requirements may be contrasted with imperative instructions that describe the exact device configuration syntax and control flow to achieve the configuration. By utilizing declarative requirements rather than imperative instructions, a user and/or user system is relieved of the burden of determining the exact device configurations required to achieve a desired result of the user/system. For example, it is often difficult and burdensome to specify and manage exact imperative instructions to configure each device of a network when various different types of devices from different vendors are utilized. The types and kinds of devices of the network may dynamically change as new devices are added and device failures occur. Managing various different types of devices from different vendors with different configuration protocols, syntax, and software versions to configure a cohesive network of devices is often difficult to achieve. Thus, by only requiring a user/system to specify declarative requirements that specify a desired result applicable across various different types of devices, management and configuration of the network devices becomes more efficient. Further example details and techniques of an intent-based network management system are described in U.S. Pat. No. 10,756,983, entitled “Intent-based Analytics,” and U.S. Pat. No. 10,992,543, entitled “Automatically generating an intent-based network model of an existing computer network,” each of which is hereby incorporated by reference.

In accordance with the techniques described in this disclosure network management system 130 may determine, based on an electrical parameter value associated with one or more circuit elements of an antenna connected to a network device of wireless network 106, wired network 175, and/or SD-WAN 177, one or more operational parameters for controlling operation of the antenna. For example, a network device of wireless network 106 may detect that an antenna is connected to the network device. The network device may use a measurement circuit to determine an electrical parameter value associated with one or more circuit elements of the antenna. The network device may send, or antenna identification engine 136 may otherwise obtain, the electrical parameter value determined by the network device. Antenna identification engine 136 may determine an identifier of the antenna based on the electrical parameter value. For example, antenna identification engine 136 may determine, using the electrical parameter value associated with the antenna to search antenna lookup table 135, data of identifying information 138 (e.g., data representing a part number, model number, serial number, manufacturing information, etc.) as the identifier of the antenna. Antenna identification engine 136 may determine one or more operational parameters of operational parameters 139 based on the identifier of the antenna. For instance, antenna identification engine 136 may determine one or more operational parameters mapped to the identifier of the antenna (e.g., indicated in identifying information 138) in antenna lookup table 135. Antenna identification engine 136 may send the one or more operational parameters to the network device to control operation of the antenna. For example, the network device may execute configuration information associated with one or more operational parameters received from NMS 130 to control parameters and/or otherwise configure antenna control settings for an antenna. While the example described above is described with respect to a network device in wireless network 106, the techniques of the disclosure may apply to any network device connected to an antenna in any of any network, such as wireless network 106, wired network 175, network device in SD-WAN 177, etc.

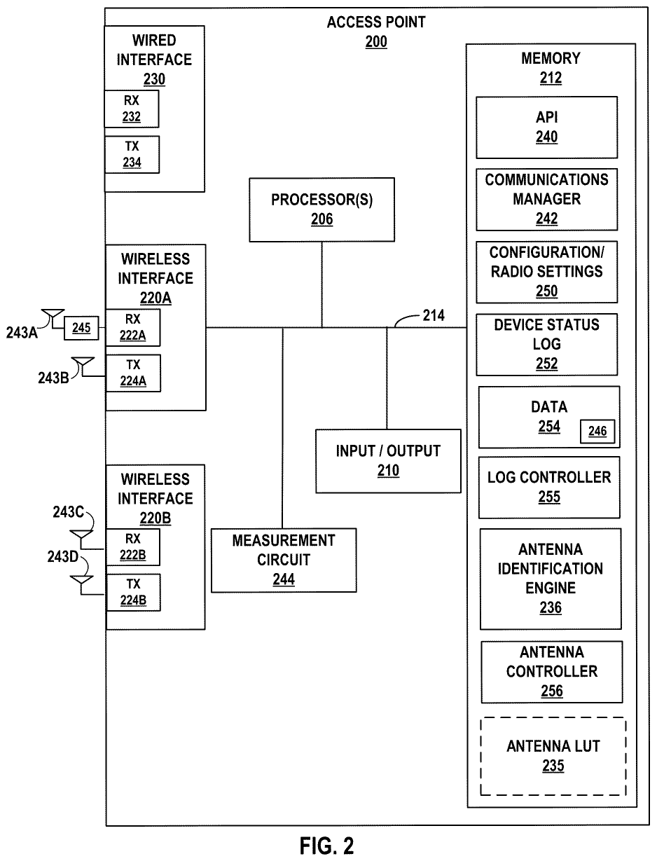

FIG. 2 is a block diagram of an example access point (AP) device 200, in accordance with one or more techniques of this disclosure. Example access point 200, antenna identification engine 236, and antenna lookup table 235 (“antenna LUT 235”) shown in FIG. 2 may be example or alternative implementations of any of APs 142, antenna identification engine 136, and antenna lookup table 135, respectively, as shown and described herein with respect to FIG. 1A. Access point 200 may comprise, for example, a Wi-Fi, Bluetooth and/or Bluetooth Low Energy (BLE) base station or any other type of wireless access point.

In the example of FIG. 2, access point 200 includes a wired interface 230, wireless interfaces 220A-220B, antennas 243A-243D (collectively referred to herein as “antennas 243”), one or more processor(s) 206, memory 212, measurement circuit 244, and input/output 210, coupled together via a bus 214 over which the various elements may exchange data and information. Wired interface 230 represents a physical network interface and includes a receiver 232 and a transmitter 234 for sending and receiving network communications, e.g., packets. Wired interface 230 couples, either directly or indirectly, access point 200 to a wired network device, such as one of switches 146 of FIG. 1A, within the wired network via a cable, such as an Ethernet cable.

First and second wireless interfaces 220A and 220B represent wireless network interfaces and include receivers 222A and 222B, respectively, each including receive antennas 243A and 243C, respectively, via which access point 200 may receive wireless signals from wireless communications devices, such as UEs 148 of FIG. 1A. First and second wireless interfaces 220A and 220B further include transmitters 224A and 224B, respectively, each including transmit antennas 243B and 243D, respectively, via which access point 200 may transmit wireless signals to wireless communications devices, such as UEs 148 of FIG. 1A. In some examples, first wireless interface 220A may include a Wi-Fi 802.11 interface (e.g., 2.4 GHz and/or 5 GHz) and second wireless interface 220B may include a Bluetooth interface and/or a Bluetooth Low Energy (BLE) interface.

Antennas 243 may include components external to access point 200 that may be connected to access point 200 to enable access point 200 to send and/or receive signals. Antennas 243 may include omnidirectional antennas, directional antennas, patch antennas, sector antennas, MIMO antennas, WHIP antenna, WIFI antennas, BLUETOOTH antennas, radio frequency antennas, global positioning system antennas, distributed antenna system antennas, or any other antennas configurable for network devices. Antenna 243A, in the example of FIG. 2, may include one or more circuit elements, e.g., circuit element(s) 245, such as one or more resistors or other circuit element or elements.

Measurement circuit 244 may include circuitry for measuring an electrical parameter value associated with circuit element(s) 245 of an antenna 243. For example, measurement circuit 244 may include hardware circuitry configured to measure resistance, impedance, current, frequency, phase, voltage, or other value associated with circuit element(s) 245 of antenna 243A. The hardware circuitry of measurement circuit 244 may include one or more of a Wheatstone Bridge, Voltage Divider Circuit, Four-Wire Measurement, ohmmeter, LCR meter, Bridge circuits, Vector Network Analyzer (VNA), current sense resistor, Hall Effect sensor, Current Transformer (CT), Operational Amplifier (Op-Amp) current sensor, voltmeter, voltage divider, differential amplifier, frequency counter, phase detector, or any other circuitry that may be configured to measure an electrical parameter value associated with one or more circuit elements of an antenna 243. In some examples, measurement circuit 244 may have a small form factor to be embedded internally to access point 200. In some instances, although illustrated as internal to access point 200, measurement circuit 244 may include an external component connected to access point 200. The electrical parameter value of circuit element(s) 245 may be stored in memory 212 (e.g., as electrical parameter value 246), such as in data storage 254.

Processor(s) 206 are programmable hardware-based processors configured to execute software instructions, such as those used to define a software or computer program, stored to a computer-readable storage medium (such as memory 212), such as non-transitory computer-readable mediums including a storage device (e.g., a disk drive, or an optical drive) or a memory (such as Flash memory or RAM) or any other type of volatile or non-volatile memory, that stores instructions to cause the one or more processors 206 to perform the techniques described herein.

Memory 212 includes one or more devices configured to store programming modules and/or data associated with operation of access point 200. For example, memory 212 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 206 to perform the techniques described herein.

In this example, memory 212 stores executable software including an application programming interface (API) 240, a communications manager 242, configuration settings 250, a device status log 252, data storage 254, log controller 255, antenna identification engine 236, antenna controller 256, and antenna LUT 235. Device status log 252 includes a list of events specific to access point 200. The events may include a log of both normal events and error events such as, for example, memory status, reboot or restart events, crash events, cloud disconnect with self-recovery events, low link speed or link speed flapping events, Ethernet port status, Ethernet interface packet errors, upgrade failure events, firmware upgrade events, configuration changes, etc., as well as a time and date stamp for each event. Log controller 255 determines a logging level for the device based on instructions from NMS 130. Data 254 may store any data used and/or generated by access point 200, including data collected from UEs 148, such as data used to calculate one or more SLE metrics, that is transmitted by access point 200 for cloud-based management of wireless networks 106A by NMS 130, and/or an electrical parameter value (e.g., electrical parameter value 246) of one or more circuit elements of antennas 143.

Input/output (I/O) 210 represents physical hardware components that enable interaction with a user, such as buttons, a display, and the like. Although not shown, memory 212 typically stores executable software for controlling a user interface with respect to input received via I/O 210. Communications manager 242 includes program code that, when executed by processor(s) 206, allow access point 200 to communicate with UEs 148 and/or network(s) 134 via any of interface(s) 230 and/or 220A-220C. Configuration settings 250 include any device settings for access point 200 such as radio settings for each of wireless interface(s) 220A-220C. These settings may be configured manually or may be remotely monitored and managed by NMS 130 to optimize wireless network performance on a periodic (e.g., hourly or daily) basis.

As described herein, AP device 200 may measure and report network data from status log 252 to NMS 130. The network data may comprise event data, telemetry data, and/or other SLE-related data. The network data may include various parameters indicative of the performance and/or status of the wireless network. The parameters may be measured and/or determined by one or more of the UE devices and/or by one or more of the APs in a wireless network. NMS 130 may determine one or more SLE metrics based on the SLE-related data received from the APs in the wireless network and store the SLE metrics as network data 137 (FIG. 1A).

In some examples, access point 200 may include antenna look up table (LUT) 235. Antenna LUT 235 may include mappings of electrical parameter values to identifier information of antennas. For example, antenna LUT 235 may include mappings between electrical parameter values (e.g., resistance values) to identifiers of antennas (e.g., antenna part number, antenna model number, antenna manufacturing information, antenna serial number, etc.). For instance, antenna LUT 235 may include a mapping of an electrical parameter value (e.g., electrical parameter value 246) associated with circuit element(s) 245 of antenna 243A and an antenna model number of antenna 243A. In some instances, antenna LUT 235 may include mappings of identifiers of antennas to one or more operational parameters to control operation of respective antennas. In some examples, access point 200 may obtain antenna LUT 235 from a network management system (e.g., NMS 130 of FIG. 1A) or a user may configure the mappings in antenna LUT 235.

In some examples, antenna identification engine 236 may provide a network management system with an electrical parameter measured from circuit element(s) 245 of antenna 243A such that the network management system may identify antenna 243A and provide one or more operational parameters to control operation of antenna 243A. For example, access point 200 may detect antenna 243A is connected to an antenna port of access point 200 or that antenna 243A is otherwise installed to be configured to operate to send and/or receive signals according to operational parameters set by access point 200. In these examples, measurement circuit 244 may determine an electrical parameter value associated with circuit element(s) 245 (e.g., one or more resistors) of antenna 243A, and the electrical parameter value associated with circuit element(s) 245 is stored in data storage 254 (illustrated as electrical parameter value 246). For example, measurement circuit 244 may initiate a signal (e.g., apply a voltage) to generate a current to flow through circuit element(s) 245 of antenna 243A and may measure a current value (milliamp) flowing through circuit element(s) 245 and/or a resistance value (ohms) of circuit element(s) 245. As another example, measurement circuit 244 may read a voltage divider circuit associated with circuit element(s) 245 connected to AP 200. Antenna identification engine 236 may send electrical parameter value 246 to a network management system (e.g., NMS 130 of FIG. 1A) to identify antenna 243A and to provide one or more operational parameters of antenna 243A.

In some examples, antenna identification engine 236 may determine an identifier of an antenna 243 based on an electrical parameter value associated with one or more electronic circuits of the antenna 243. For example, antenna identification engine 236 may instruct measurement circuit 244 to determine electrical parameter 246 based on circuit element(s) 245 of antenna 243A. Antenna identification engine 236 may determine an identifier of antenna 243A based on an electrical parameter value 246 associated with circuit element(s) 245. For instance, antenna identification engine 236 may search antenna LUT 235 for an identifier associated with antenna 243A that is mapped to or otherwise indexed by electrical parameter value 246. Antenna identification engine 236 may send the identifier associated with antenna 243A to a network management system (e.g., NMS 130 of FIG. 1A) to identify antenna 243A and to provide one or more operational parameters of antenna 243A.

In some examples, antenna identification engine 236 may determine one or more operational parameters based on an identifier of an antenna. For instance, in examples where antenna LUT 235 includes a mapping of one or more operational parameters to an identifier of antenna 243A, antenna identification engine 236 may search antenna LUT 235 for the one or more operational parameters mapped to the identifier of antenna 243A and may send the one or more operational parameters for antenna 243A to antenna controller 256 to control operation of antenna 243A based on the one or more operational parameters.

Antenna controller 256 may control operation of antennas 243. Antenna controller 256 may control operation of antennas 243 according to respective operational parameters determined for antennas 243, such as antenna gains, transmission power limits, beamforming information, channel selection, band selection, or the like. For instance, antenna controller 256 may receive one or more operational parameters from the network management system and may update configuration settings 250 based on the one or more operational parameters (e.g., antenna gain, channel, band, etc.) to control the operation of antenna 243A. In another instance, antenna controller 256 may update configuration settings 250 based on the one or more operational parameters (e.g., antenna gain, channel, band, etc.) determined by antenna identification engine 236 to control the operation of antenna 243A.

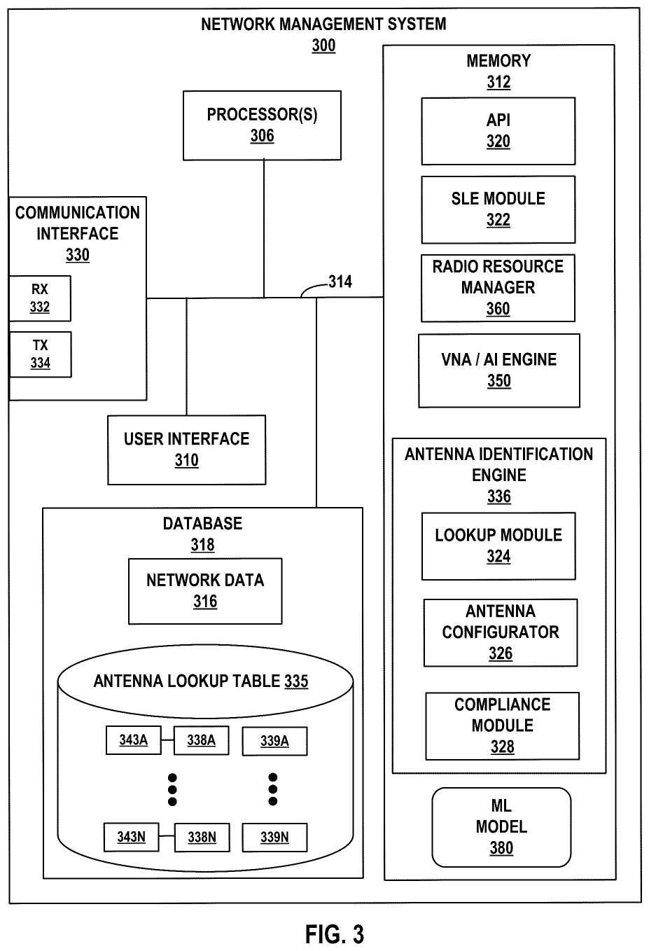

FIG. 3 is a block diagram of an example network management system (NMS) 300, in accordance with one or more techniques of the disclosure. NMS 300 may be used to implement, for example, NMS 130 in FIGS. 1A-1B. In such examples, NMS 300 is responsible for monitoring and management of one or more wireless networks 106A-106N at sites 102A-102N, respectively. Antenna lookup table 335, operational parameters 339A-339N, identifying information 338A-338N, and antenna identification engine 336 of FIG. 3 may be example or alternative implementations of antenna lookup table 135, operational parameters 139, identifying information 138, and antenna identification engine 136 of FIG. 1, respectively.

NMS 300 includes a communications interface 330, one or more processor(s) 306, a user interface 310, a memory 312, and a database 318. The various elements are coupled together via a bus 314 over which the various elements may exchange data and information. In some examples, NMS 300 receives data from one or more of client devices 148, APs 142, switches 146 and other network nodes within network 134, e.g., routers 187 of FIG. 1B, which may be used to calculate one or more SLE metrics and/or update network data 316 in database 318. NMS 300 analyzes this data for cloud-based management of wireless networks 106A-106N. In some examples, NMS 300 may be part of another server shown in FIG. 1A or a part of any other server.

Database 318, in the example of FIG. 3, may include antenna lookup table 335. Antenna lookup table 335 may include an index or mappings of operational parameters 339A-339N (collectively referred to as “operational parameters 339”) to identifying information 338A-338N (collectively referred to as “identifying information 338”). Antenna lookup table 335 may include mappings of operational parameters 339 to identifying information 338 as that indicate a relationship associated with one identifier of identifying information 338 mapped to one or more operational parameters of operational parameters 339. In the example of FIG. 3, antenna lookup table 335 may include mappings of operational parameters 339 to identifying information 338 that are indexed according to respective electrical parameter values 343A-343N (collectively referred to as “electrical parameter values 343”). For instance, antenna lookup table 335 may store electrical parameter values 343 as keys that may be used to lookup or otherwise fetch mappings of operational parameters 339 to identifying information 338.

Processor(s) 306 execute software instructions, such as those used to define a software or computer program, stored to a computer-readable storage medium (such as memory 312), such as non-transitory computer-readable mediums including a storage device (e.g., a disk drive, or an optical drive) or a memory (such as Flash memory or RAM) or any other type of volatile or non-volatile memory, that stores instructions to cause the one or more processors 306 to perform the techniques described herein.

Communications interface 330 may include, for example, an Ethernet interface. Communications interface 330 couples NMS 300 to a network and/or the Internet, such as any of network(s) 134 as shown in FIG. 1A, and/or any local area networks. Communications interface 330 includes a receiver 332 and a transmitter 334 by which NMS 300 receives/transmits data and information to/from any of client devices 148, APs 142, switches 146, servers 110, 116, 122, 128 and/or any other network nodes, devices, or systems forming part of network system 100 such as shown in FIG. 1A. In some scenarios described herein in which network system 100 includes “third-party” network devices that are owned and/or associated with different entities than NMS 300, NMS 300 does not receive, collect, or otherwise have access to network data from the third-party network devices.

The data and information received by NMS 300 may include, for example, telemetry data, SLE-related data, or event data received from one or more of client device APs 148, APs 142, switches 146, or other network nodes, e.g., routers 187 of FIG. 1B, used by NMS 300 to remotely monitor the performance of wireless networks 106A-106N and application sessions from client device to cloud-based application server. NMS 300 may further transmit data via communications interface 330 to any of network devices such as client devices 148, APs 142, switches 146, other network nodes within network 134, admin device 111 to remotely manage wireless networks 106A-106N and portions of the wired network.

Memory 312 includes one or more devices configured to store programming modules and/or data associated with operation of NMS 300. For example, memory 312 may include a computer-readable storage medium, such as a non-transitory computer-readable medium including a storage device (e.g., a disk drive, or an optical drive) or a memory (such as Flash memory or RAM) or any other type of volatile or non-volatile memory, that stores instructions to cause the one or more processor(s) 306 to perform the techniques described herein.

In this example, memory 312 includes an API 320, an SLE module 322, a virtual network assistant (VNA)/AI engine 350, antenna identification engine 336, machine learning (ML) model 380, and a radio resource management (RRM) engine 360. NMS 300 may also include any other programmed modules, software engines and/or interfaces configured for remote monitoring and management of wireless networks 106A-106N and portions of the wired network, including remote monitoring and management of any of APs 142/200, switches 146, or other network devices, e.g., routers 187 of FIG. 1B.

SLE module 322 enables set up and tracking of thresholds for SLE metrics for each network 106A-106N. SLE module 322 further analyzes SLE-related data collected by APs, such as any of APs 142 from UEs in each wireless network 106A-106N. For example, APs 142A-1 through 142A-N collect SLE-related data from UEs 148A-1 through 148A-N currently connected to wireless network 106A. This data is transmitted to NMS 300, which executes by SLE module 322 to determine one or more SLE metrics for each UE 148A-1 through 148A-N currently connected to wireless network 106A. This data, in addition to any network data collected by one or more APs 142A-1 through 142A-N in wireless network 106A, is transmitted to NMS 300 and stored as, for example, network data 316 in database 318.

RRM engine 360 monitors one or more metrics for each site 102A-102N in order to learn and optimize the RF environment at each site. For example, RRM engine 360 may monitor the coverage and capacity SLE metrics for a wireless network 106 at a site 102 in order to identify potential issues with SLE coverage and/or capacity in the wireless network 106 and to make adjustments to the radio settings of the access points at each site to address the identified issues. For example, RRM engine may determine channel and transmit power distribution across all APs 142 in each network 106A-106N. For example, RRM engine 360 may monitor events, power, channel, bandwidth, and number of clients connected to each AP. RRM engine 360 may further automatically change or update configurations of one or more APs 142 at a site 102 with an aim to improve the coverage and capacity SLE metrics and thus to provide an improved wireless experience for the user.

VNA/AI engine 350 analyzes data received from network devices as well as its own data to identify when undesired to abnormal states are encountered at one of the network devices. For example, VNA/AI engine 350 may identify the root cause of any undesired or abnormal states, e.g., any poor SLE metric(s) indicative of connected issues at one or more network devices. In addition, VNA/AI engine 350 may automatically invoke one or more corrective actions intended to address the identified root cause(s) of one or more poor SLE metrics. Examples of corrective actions that may be automatically invoked by VNA/AI engine 350 may include, but are not limited to, invoking RRM 360 to reboot one or more APs, adjusting/modifying the transmit power of a specific radio in a specific AP, adding SSID configuration to a specific AP, changing channels on an AP or a set of APs, etc. The corrective actions may further include restarting a switch and/or a router, invoking downloading of new software to an AP, switch, or router, etc. These corrective actions are given for example purposes only, and the disclosure is not limited in this respect. If automatic corrective actions are not available or do not adequately resolve the root cause, VNA/AI engine 350 may proactively provide a notification including recommended corrective actions to be taken by IT personnel, e.g., a site or network administrator using admin device 111, to address the network error.

In accordance with one or more techniques of this disclosure, antenna identification engine 336 may determine one or more operational parameters of operational parameters 339 to control operation of an antenna of a network device managed by NMS 300. Lookup module 324 of antenna identification engine 336 may obtain an electrical parameter value from a network device (e.g., responsive to the network device detecting the electrical parameter value from one or more circuit elements of an antenna connected to the network device). For example, lookup module 324 may obtain electrical parameter 246, of FIG. 2, that is associated with circuit element(s) 245 of antenna 243A. Lookup module 324 may use the electrical parameter value to query or otherwise search antenna lookup table 335 for an antenna identifier associated with the electrical parameter value. For example, lookup module 324 may obtain an electrical parameter value 246 associated with circuit element(s) 245 of antenna 243A, of FIG. 2, that matches electrical parameter value 343A. Lookup module 324 may determine that obtained electrical parameter value 343A corresponds to identifying information 338A. Lookup module 324 may determine an identifier of antenna 243A based on data of identifying information 338A indicating the identifier, such as data representing a part number associated with antenna 243A.

Lookup module 324 may determine one or more operational parameters based on a determined identifier of an antenna connected to a network device. For example, lookup module 324 may determine an identifier of antenna 243A, of FIG. 2, as identifying information 338A based on obtaining electrical parameter value 246 corresponding to circuit element(s) 245. Lookup module 324 may fetch or otherwise obtain data from antenna lookup table 335 indicating one or more operational parameters of operational parameters 339 that are mapped to identifying information 338A. For example, lookup module 324 may obtain operational parameters 339A that are mapped to identifying information 338A in antenna LUT 235, to control operation of antenna 243A of FIG. 2 and according to the example above. Lookup module 324 may send determined one or more operational parameters to antenna configurator 326.

Antenna configurator 326 of antenna identification engine 336 may send information to network devices associated with configuring the network devices to control operation of connected antennas. For example, antenna configurator 326 may determine configuration information associated with operating an antenna in compliance with regulatory standards based on one or more operational parameters determined by lookup module 324. In some examples, antenna configurator 326 may send determined one or more operational parameters to network devices, such that the network devices may configure operation of connected antennas according to the one or more operational parameters. For example, according to the example described above, antenna configurator 326 may send operational parameters 339A to access point 200 of FIG. 2 to control operation of antenna 243A.

In some instances, antenna configurator 326 may send determined identifiers of antennas to network devices, such that network devices may determine operational parameters to control operation of connected antennas according to the identifiers of the antennas. In some examples, antenna configurator may output user interface 310 to include identifiers of respective antennas determined according to electrical parameter values.

Compliance module 328 of antenna identification engine 336 may update operational parameters 339. For example, compliance module 328 may determine whether there are any changes to regulatory standards, such as FCC standards. Compliance module 328 may monitor regulatory standards associated with operation of antennas in various geographic locations to determine whether there are any changes to the regulatory standards. Based on determining a change to a regulatory standard, compliance module 328 may update mappings of operational parameters 339 to identifying information 338 at antenna lookup table 335. For example, based on detecting a change to a regulatory standard, compliance module 328 may update operational parameters, or mappings thereof, associated with an antenna power limit (e.g., antenna gain) of a particular antenna to comply with the change to the regulatory standard (e.g., update an antenna power limit to comply with an updated regulatory standard). In some examples, compliance module 328 may update mappings of operational parameters 339 to identifying information 338 to include information associated with compliance standards for operating antennas of network devices.

In some examples, ML model 380 may comprise a supervised ML model that is trained, using training data comprising pre-collected, labeled network data received from network devices (e.g., client devices, APs, switches and/or other network nodes), to identify changes in regulatory compliance standards associated with operation of antennas for network devices. The supervised ML model may comprise one of a logistical regression, naïve Bayesian, support vector machine (SVM), or the like. In other examples, ML model 380 may comprise an unsupervised ML model. Although not shown in FIG. 3, in some examples, database 318 may store the training data and VNA/AI engine 350 or a dedicated training module may be configured to train ML model 380 based on the training data to determine appropriate weights across the one or more features of the training data.

The techniques of this disclosure provide one or more technical advantages and practical applications. For example, NMS 300 may automatically determine operational parameters to control operation of antennas connected to network devices. Rather than NMS 300 sending operational parameters to network devices according to manually input antenna identification information, NMS 300 may determine operational parameters according to an electrical parameter received from a network device that detected an antenna. In this way, NMS 300 may ensure that network devices control operation of antenna to comply with regulatory standards by, for example, accurately identifying an antenna. Additionally, or alternatively, NMS 300 may send antenna control information to network devices based on values associated with circuit elements of antennas; potentially reducing time and/or computational resources (e.g., processing resources, memory resources, power consumption, etc.) associated with processing identification data that may be hard-coded on antennas (e.g., in a memory device embedded on the antennas).

Although the techniques of the present disclosure are described in this example as performed by NMS 130, techniques described herein may be performed by any other computing device(s), system(s), and/or server(s), and that the disclosure is not limited in this respect. For example, one or more computing device(s) configured to execute the functionality of the techniques of this disclosure may reside in a dedicated server or be included in any other server in addition to or other than NMS 130, or may be distributed throughout network 100, and may or may not form a part of NMS 130.

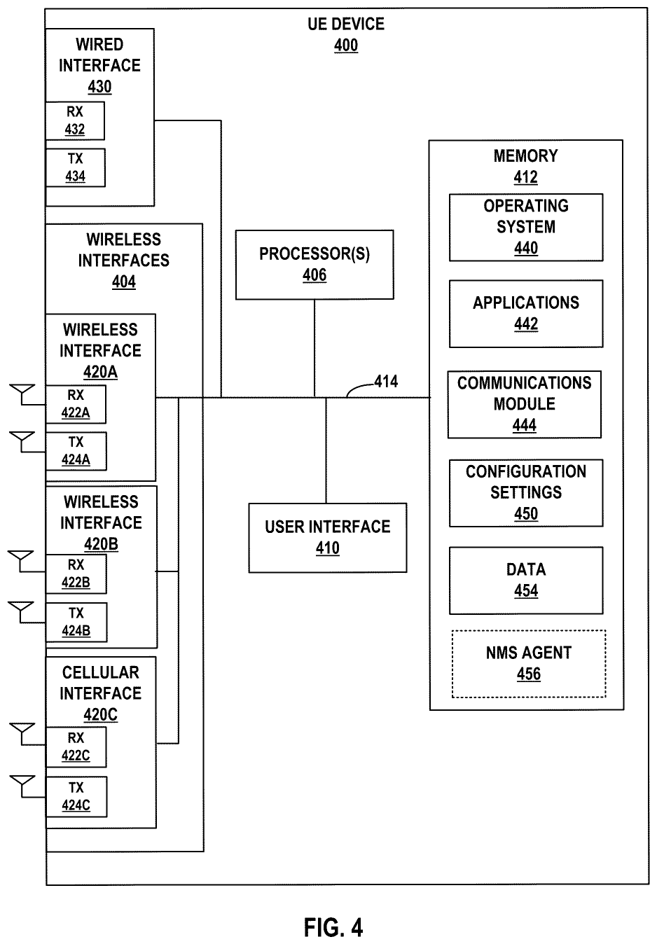

FIG. 4 shows an example user equipment (UE) device 400, in accordance with one or more techniques of this disclosure. Example UE device 400 shown in FIG. 4 may be used to implement any of UEs 148 as shown and described herein with respect to FIG. 1A. UE device 400 may include any type of wireless client device, and the disclosure is not limited in this respect. For example, UE device 400 may include a mobile device such as a smart phone, tablet or laptop computer, a personal digital assistant (PDA), a wireless terminal, a smart watch, a smart ring, or any other type of mobile or wearable device. In some examples, UE 400 may also include a wired client-side device, e.g., an IoT device such as a printer, a security sensor or device, an environmental sensor, or any other device connected to the wired network and configured to communicate over one or more wireless networks.

UE device 400 includes a wired interface 430, wireless interfaces 420A-420C, one or more processor(s) 406, memory 412, and a user interface 410. The various elements are coupled together via a bus 414 over which the various elements may exchange data and information. Wired interface 430 represents a physical network interface and includes a receiver 432 and a transmitter 434. Wired interface 430 may be used, if desired, to couple, either directly or indirectly, UE 400 to a wired network device, such as one of switches 146 of FIG. 1A, within the wired network via a cable, such as one of Ethernet cables 144 of FIG. 1A.

First, second and third wireless interfaces 420A, 420B, and 420C include receivers 422A, 422B, and 422C, respectively, each including a receive antenna via which UE 400 may receive wireless signals from wireless communications devices, such as APs 142 of FIG. 1A, AP 200 of FIG. 2, other UEs 148, or other devices configured for wireless communication. First, second, and third wireless interfaces 420A, 420B, and 420C further include transmitters 424A, 424B, and 424C, respectively, each including transmit antennas via which UE 400 may transmit wireless signals to wireless communications devices, such as APs 142 of FIG. 1A, AP 200 of FIG. 2, other UEs 148 and/or other devices configured for wireless communication. In some examples, first wireless interface 420A may include a Wi-Fi 802.11 interface (e.g., 2.4 GHz and/or 5 GHz) and second wireless interface 420B may include a Bluetooth interface and/or a Bluetooth Low Energy interface. Third wireless interface 420C may include, for example, a cellular interface through which UE device 400 may connect to a cellular network.

Processor(s) 406 execute software instructions, such as those used to define a software or computer program, stored to a computer-readable storage medium (such as memory 412), such as non-transitory computer-readable mediums including a storage device (e.g., a disk drive, or an optical drive) or a memory (such as Flash memory or RAM) or any other type of volatile or non-volatile memory, that stores instructions to cause the one or more processors 406 to perform the techniques described herein.

Memory 412 includes one or more devices configured to store programming modules and/or data associated with operation of UE 400. For example, memory 412 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 406 to perform the techniques described herein.

In this example, memory 412 includes an operating system 440, applications 442, a communications module 444, configuration settings 450, and data storage 454. Communications module 444 includes program code that, when executed by processor(s) 406, enables UE 400 to communicate using any of wired interface(s) 430, wireless interfaces 420A-420B and/or cellular interface 450C. Configuration settings 450 include any device settings for UE 400 settings for each of wireless interface(s) 420A-420B and/or cellular interface 420C.

Data storage 454 may include, for example, a status/error log including a list of events specific to UE 400. The events may include a log of both normal events and error events according to a logging level based on instructions from NMS 130. Data storage 454 may store any data used and/or generated by UE 400, such as data used to calculate one or more SLE metrics or identify relevant behavior data, that is collected by UE 400 and either transmitted directly to NMS 130 or transmitted to any of APs 142 in a wireless network 106 for further transmission to NMS 130.

As described herein, UE 400 may measure and report network data from data storage 454 to NMS 130. The network data may comprise event data, telemetry data, and/or other SLE-related data. The network data may include various parameters indicative of the performance and/or status of the wireless network. NMS 130 may determine one or more SLE metrics and store the SLE metrics as network data 137 (FIG. 1A) based on the SLE-related data received from the UEs or client devices in the wireless network.

Optionally, UE device 400 may include an NMS agent 456. NMS agent 456 is a software agent of NMS 130 that is installed on UE 400. In some examples, NMS agent 456 can be implemented as a software application running on UE 400. NMS agent 456 collects information including detailed client-device properties from UE 400, including insight into UE 400 roaming behaviors. The information provides insight into client roaming algorithms, because roaming is a client device decision. In some examples, NMS agent 456 may display the client-device properties on UE 400. NMS agent 456 sends the client device properties to NMS 130, via an AP device to which UE 400 is connected. NMS agent 456 can be integrated into a custom application or as part of location application. NMS agent 456 may be configured to recognize device connection types (e.g., cellular or Wi-Fi), along with the corresponding signal strength. For example, NMS agent 456 recognizes access point connections and their corresponding signal strengths. NMS agent 456 can store information specifying the APs recognized by UE 400 as well as their corresponding signal strengths. NMS agent 456 or other element of UE 400 also collects information about which APs the UE 400 connected with, which also indicates which APs the UE 400 did not connect with. NMS agent 456 of UE 400 sends this information to NMS 130 via its connected AP. In this manner, UE 400 sends information about not only the AP that UE 400 connected with, but also information about other APs that UE 400 recognized and did not connect with, and their signal strengths. The AP in turn forwards this information to the NMS, including the information about other APs the UE 400 recognized besides itself. This additional level of granularity enables NMS 130, and ultimately network administrators, to better determine the Wi-Fi experience directly from the client device's perspective.

In some examples, NMS agent 456 further enriches the client device data leveraged in service levels. For example, NMS agent 456 may go beyond basic fingerprinting to provide supplemental details into properties such as device type, manufacturer, and different versions of operating systems. In the detailed client properties, the NMS 130 can display the Radio Hardware and Firmware information of UE 400 received from NMS client agent 456. The more details the NMS agent 456 can draw out, the better the VNA/AI engine gets at advanced device classification. The VNA/AI engine of the NMS 130 continually learns and becomes more accurate in its ability to distinguish between device-specific issues or broad device issues, such as specifically identifying that a particular OS version is affecting certain clients.

In some examples, NMS agent 456 may cause user interface 410 to display a prompt that prompts an end user of UE 400 to enable location permissions before NMS agent 456 is able to report the device's location, client information, and network connection data to the NMS. NMS agent 456 will then start reporting connection data to the NMS along with location data. In this manner, the end user of the client device can control whether the NMS agent 456 is enabled to report client device information to the NMS.

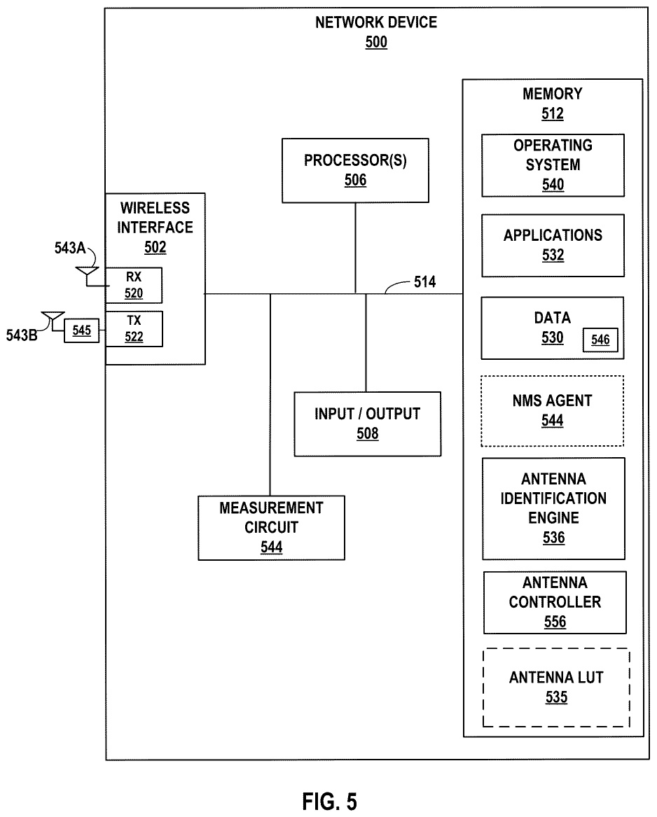

FIG. 5 is a block diagram illustrating example network device 500, in accordance with one or more techniques of this disclosure. In one or more examples, the network device 500 implements a device or a server attached to the network 134 of FIG. 1A, e.g., switches 146, access points 142, AAA server 110, DHCP server 116, DNS server 122, web servers 128, gateway devices, etc., or another network device supporting one or more of wireless network 106, wired LAN 175, or SD-WAN 177, or data center 179 of FIG. 1B, e.g., routers 187. Wireless interface 502, receiver 520, transceiver 522, antennas 543A-543B, one or more circuit element(s) 545, electrical parameter value 546, measurement circuit 544, antenna identification engine 536, antenna controller 556, and antenna lookup table 535 (“antenna LUT 535”) of FIG. 5 may be example or alternative implementations of wireless interfaces 220A-220B, receivers 222A-222B, transceivers 224A-224B, antennas 243A-243D, one or more circuit element(s) 245, electrical parameter value 246, measurement circuit 244, antenna identification engine 236, antenna controller 256, and antenna LUT 235 of FIG. 2, respectively.

In this example, network device 500 includes wireless interface 502, measurement circuit 544, a processor 506, input/output 508, e.g., display, buttons, keyboard, keypad, touch screen, mouse, etc., and a memory 512 coupled together via a bus 514 over which the various elements may interchange data and information. Wireless interface 502 couples the network device 500 to a network, such as an enterprise network. Though only one interface is shown by way of example, network nodes may, and usually do, have multiple communication interfaces and/or multiple communication interface ports. Wireless interface 502 includes a receiver 520 connected to antenna 543A and a transmitter 522 connected to antenna 543B.

Memory 512 stores executable software applications 532, operating system 540, antenna identification engine 536, antenna controller 556, NMS agent 544, antenna LUT 535, and data/information 530. Data 530 may include a system log and/or an error log that stores event data, including behavior data and/or an electrical parameter value (e.g., electrical parameter value 546), for network device 500. In examples where network device 500 comprises a “third-party” network device, the same entity does not own or have access to both the APs or wired client-side devices and network device 500. As such, in the example where network device 500 is a third-party network device, NMS 130 does not receive, collect, or otherwise have access to the network data from network device 500.

In examples where network device 500 comprises a server, network device 500 may receive data and information, e.g., including operation related information, e.g., registration request, AAA services, DHCP requests, Simple Notification Service (SNS) look-ups, and Web page requests via receiver 520, and send data and information, e.g., including configuration information, authentication information, web page data, etc. via transmitter 522.

In examples where network device 500 comprises a session-based router that employs a stateful, session-based routing scheme, network device 500 may be configured to independently perform path selection and traffic engineering. The use of session-based routing may enable network device 500 to eschew the use of a centralized controller, such as an SDN controller, to perform path selection and traffic engineering, and eschew the use of tunnels. In some examples, network device 500 may implement session-based routing as Secure Vector Routing (SVR), provided by Juniper Networks, Inc. In the case where network node device comprises a session-based router operating as a network gateway for a site of an enterprise network (e.g., router 187A of FIG. 1B), network device 500 may establish multiple peer paths (e.g., logical path 189 of FIG. 1B) over an underlying physical WAN (e.g., SD-WAN 177 of FIG. 1B) with one or more other session-based routers operating as network gateways for other sites of the enterprise network (e.g., router 187B of FIG. 1B). Network device 500, operating as a session-based router, may collect data at a peer path level, and report the peer path data to NMS 130.

In examples where network device 500 comprises a packet-based router, network device 500 may employ a packet-or flow-based routing scheme to forward packets according to defined network paths, e.g., established by a centralized controller that performs path selection and traffic engineering. In the case where network device 500 comprises a packet-based router operating as a network gateway for a site of an enterprise network (e.g., router 187A of FIG. 1B), network device 500 may establish multiple tunnels (e.g., logical path 189 of FIG. 1B) over an underlying physical WAN (e.g., SD-WAN 177 of FIG. 1B) with one or more other packet-based routers operating as network gateways for other sites of the enterprise network (e.g., router 187B of FIG. 1B). Network device 500, operating as a packet-based router, may collect data at a tunnel level, and the tunnel data may be retrieved by NMS 130 via an API or an open configuration protocol or the tunnel data may be reported to NMS 130 by NMS agent 544 or other module running on network device 500.

The data collected and reported by network device 500 may include periodically-reported data and event-driven data. Network device 500 is configured to collect logical path statistics via bidirectional forwarding detection (BFD) probing and data extracted from messages and/or counters at the logical path (e.g., peer path or tunnel) level. In some examples, network device 500 is configured to collect statistics and/or sample other data according to a first periodic interval, e.g., every 3 seconds, every 5 seconds, etc. Network device 500 may store the collected and sampled data as path data, e.g., in a buffer.

In some examples, network device 500 optionally includes an NMS agent 544. NMS agent 544 may periodically create a package of the statistical data according to a second periodic interval, e.g., every 3 minutes. The collected and sampled data periodically-reported in the package of statistical data may be referred to herein as “oc-stats.” In some examples, the package of statistical data may also include details about clients connected to network device 500 and the associated client sessions. NMS agent 544 may then report the package of statistical data to NMS 130 in the cloud. In other examples, NMS 130 may request, retrieve, or otherwise receive the package of statistical data from network device 500 via an API, an open configuration protocol, or another of communication protocols. The package of statistical data created by NMS agent 544 or another module of network device 500 may include a header identifying network device 500 and the statistics and data samples for each of the logical paths from network device 500. In still other examples, NMS agent 544 reports event data to NMS 130 in the cloud in response to the occurrence of certain events at network device 500 as the events happen. The event-driven data may be referred to herein as “oc-events.”

In accordance with the techniques described herein, network device 500 may determine electrical parameter values of antennas to control operation of the antennas. For example, antenna identification engine 536 of network device 500 may use measurement circuit 544 to determine electrical parameter value 546 associated with circuit element(s) 545 of antenna 543B. Antenna identification engine 536 may detect that antenna 543B is connected to or is otherwise installed at network device 500. Antenna identification engine 536 may instruct measurement circuit 544 to send a signal to circuit element(s) 545 of antenna 543B to determine an electrical parameter value (e.g., apply a voltage to circuit element(s) 545 to determine a measured current value or resistance value indicated in electrical parameter value 546 stored at data 530).

In some examples, antenna identification engine 536 may send electrical parameter value 546 to a network management system (e.g., network management system 300 of FIG. 3). Antenna controller 556 may obtain, from the network management system, one or more operational parameters (e.g., that the network management system determined based on electrical parameter value 546) to control operation of antenna 543B.

In some examples, antenna controller 556 may control operation of antenna 543B according to antenna identifying information that antenna identification engine 536 may have determined using antenna LUT 535. For example, antenna identification engine 536 may search antenna LUT 535 for an identifier associated with antenna 543B based on determining electrical parameter value 546 associated with circuit element(s) 545. Antenna identification engine 536 may determine the identifier associated with antenna 543B as identification of antenna LUT 535 mapped to electrical parameter value. Antenna identification engine 536 may send the identifier associated with antenna 543B to a network management system (e.g., NMS 130 of FIG. 1A) to determine one or more operational parameters mapped to the identifier associated with antenna 543B. Antenna controller 556 may obtain the one or more operational parameters to control operation of antenna 543B according to the one or more operational parameters.

In some instances, antenna identification engine 536 may determine one or more operational parameters to control operation of antenna 543B based on the one or more operational parameters being mapped to the identifier associated with antenna 543B in antenna LUT 535. Antenna identification engine 536 may send the one or more operational parameters to antenna controller 556 to control operation of antenna 543B according to the one or more operational parameters.

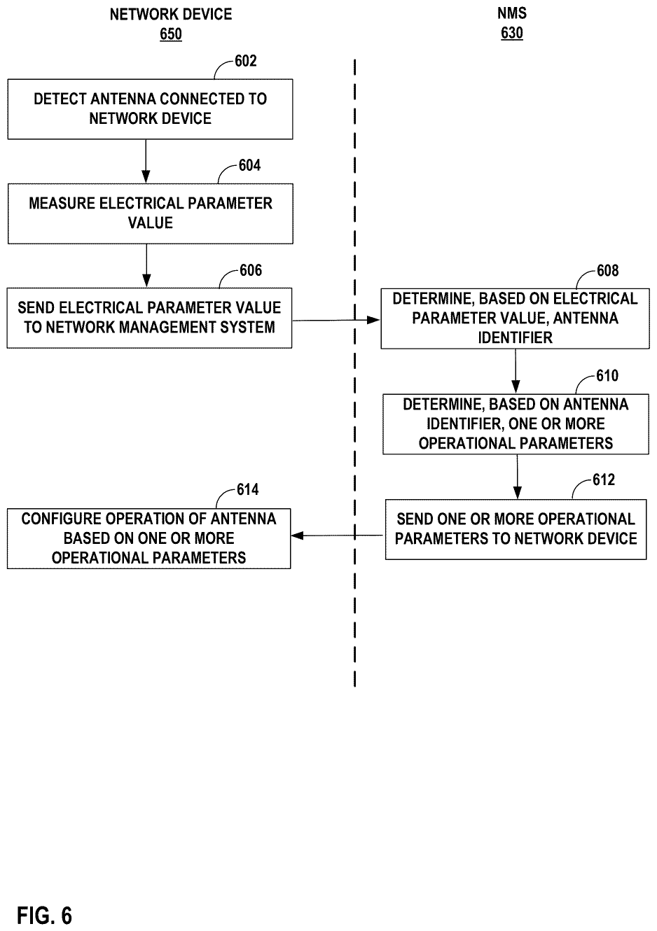

FIG. 6 is a flow chart illustrating an example operation of a system including example network device 650 and example network management system 630, in accordance with one or more techniques of this disclosure. Network device 650 of FIG. 6 may be an example or alternative implementation of network device 500 of FIG. 5. Network management system 630 of FIG. 6 may be an example or alternative implementation of network management system 300 of FIG. 3.

Network device 650 may detect an antenna connected to network device 650 (602). For example, network device 650 may detect an antenna connected to network device 650 based on detecting a signal from the antenna when the antenna is connected to a port of network device 650. Network device 650 may perform an initial installation of the antenna, such as obtaining configuration information associated with controlling operation of the antenna based on operational parameters (e.g., controlling transmission power of the antenna based on an antenna gain).

Network device 650 may measure an electrical parameter value associated with an antenna connected to network device 650 (604). For example, based on detecting an antenna, network device 650 may use a measurement circuit to measure an electrical parameter value (e.g., resistance, impedance, current, etc.) of one or more circuit elements of the antenna. Network device 650 may send the electrical parameter value to network management system 630 (606).

Network management system 630 may determine, based on the electrical parameter value, an antenna identifier (608). For example, network management system 630 may have access to an antenna lookup table that includes a mapping of the electrical parameter value to the antenna identifier (e.g., an antenna part number of the antenna). Network management system 630 may search the antenna lookup table to obtain the antenna identifier. In some examples, network management system 630 may send the antenna identifier to network device 650, such that network device 650 may determine operational parameters to control operation of the antenna.

Network management system 630 may determine, based on the antenna identifier, one or more operational parameters (610). For example, network management system 630 may have access to an antenna lookup table that further includes mappings of antenna identifiers to operational parameters associated with operating corresponding antennas to comply with regulatory standards. Network management system 630 may use the antenna lookup table to determine the one or more operational parameters as operational parameters mapped to the antenna identifier determined based on the electrical parameter value. Network management system 630 may send the one or more operational parameters to network device 650 (612).

Network device 650 may configure operation of the antenna based on the one or more operational parameters (614). For example, network device 650 may store antenna configuration information associated with operating the antenna according to the one or more operational parameters (e.g., store configuration information to operate the antenna according to an antenna gain, transmission power limit, etc.). Network device 650 may execute the antenna configuration information to operate the antenna (e.g., to send and/or receive packets or other signals) according to the one or more operational parameters.

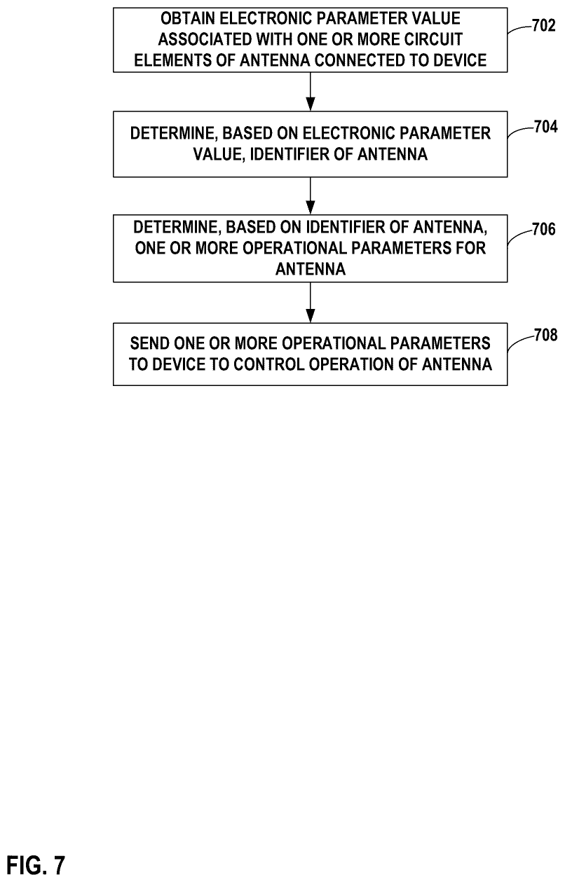

FIG. 7 is a flow chart illustrating an example operation of a network management system, in accordance with one or more techniques of this disclosure. FIG. 7 may be discussed with respect to FIG. 3, for example purposes only.

Network management system 300 may obtain an electrical parameter value associated with one or more circuit elements of an antenna connected to a device (702). For example, network management system 300 may obtain an electrical parameter value that matches electrical parameter value 343N from a device-managed by network management system 300. Network management system 300 may determine, based on the electrical parameter value, an identifier of the antenna (704). For example, network management system 300 may search, based on the electrical parameter value matching electrical parameter value 343N, antenna lookup table 335 to determine an identifier of the antenna (e.g., a part number, a model number, manufacturer information, serial number, etc.) included identifying information 338N. In some examples, network management system 300 may obtain the identifier of the antenna from the device. For example, network management system 300 may obtain the identifier of the antenna based on the device determining the identifier of the antenna according to the electrical parameter value.

Network management system 300 may determine, based on the identifier of the antenna, one or more operational parameters for the antenna (706). For example, network management system 300 may search, based on a determined identifier of an antenna associated with identifying information 338N, antenna lookup table 335 to determine one or more operational parameters of operational parameters 339 that are mapped to the determined identifier of the antenna. In some examples, network management system 300 may determine the one or more operational parameters based on an identifier of the antenna obtained from the device.

Network management system 300 may send the one or more operational parameters to the device to control operation of the antenna (708). For example, network management system 300 may send the one or more operational parameters to the device such that the device controls an antenna gain, transmission power limit, or the like during operation of the antenna to send and/or receive data.

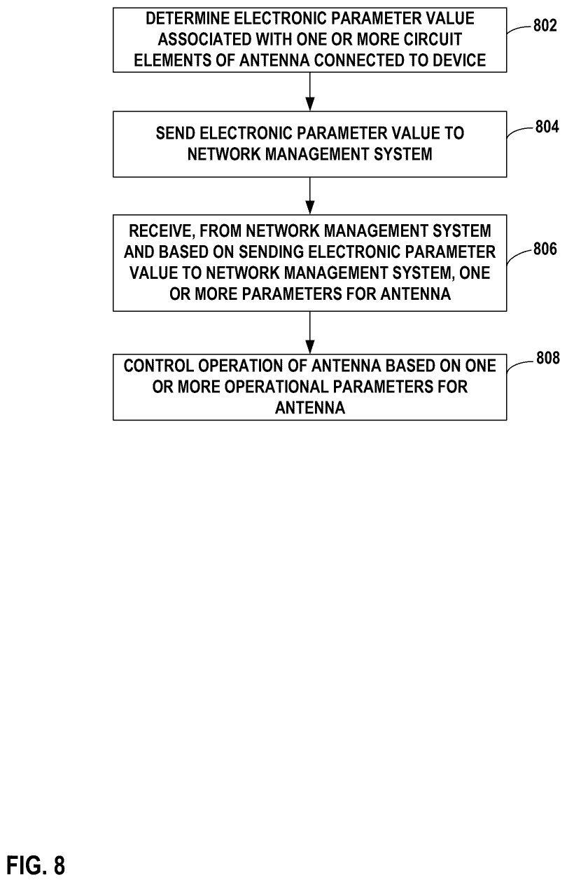

FIG. 8 is a flow chart illustrating an example operation of a network device, in accordance with one or more techniques of this disclosure. FIG. 8 may be discussed with respect to FIG. 5 for example purposes only.

Network device 500 may determine an electrical parameter value associated with one or more circuit elements of an antenna connected to network device 500 (802). For example, network device 500 may use measurement circuit 544 to measure an electrical parameter value associated with one or more circuit elements of antenna 543A (e.g., measure a resistance value of resistors connected in series, connected in parallel, or any combination thereof). Network device 500 may send the electrical parameter value to a network management system (804). The network management system may use the electrical parameter value to search an antenna lookup table to determine one or more operational parameters to control operation of the antenna.

In some examples, network device 500 may determine an identifier of an antenna based on an electrical parameter value. For example, network device 500 may include an antenna lookup table that maps an electrical parameter value to an identifier of an antenna. Network device 500 may search the antenna lookup table to determine the identifier of the antenna based on the electrical parameter value being determined from one or more circuit elements of the antenna. Network device 500 may send the identifier of the antenna to a network management server to provide one or more operational parameters (e.g., mapped to the identifier of the antenna) to network device 500 to control operation of the antenna. In some examples, the antenna lookup table of network device 500 may map the one or more operational parameters to the identifier of the antenna, such that network device 500 may determine the one or more operational parameters to control operation of the antenna without sending antenna information to a network management server.

Network device 500 may receive, from the network management system and based on sending the electrical parameter value to the network management system, one or more operational parameters for the antenna (806). For example, based on the network management system determining one or more operational parameters (e.g., antenna gain) based on obtaining the electrical parameter value, the network management system may send the one or more operational parameters to network device 500. Network device 500 may control operation of the antenna based on the one or more operational parameters for the antenna (808). For example, network device 500 may execute configuration information associated with the one or more operational parameters (e.g., execute configuration information associated with an antenna gain that complies with regulatory standards) to control operation of the antenna when network device 500 uses the antenna to send and/or receive data. In some instances, network device 500 may determine, based on the electrical parameter value, an identifier of the antenna and/or determine, based on the identifier of the antenna, one or more operational parameters for the antenna based on, for example, locally stored data associated with an antenna lookup table.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such as a processor or an integrated circuit device, such as an integrated circuit chip or chipset. Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random access memory (RAM), read-only memory (ROM), non-volatile random access memory (NVRAM), electrically erasable programmable read-only memory (EEPROM), Flash memory, magnetic or optical data storage media, and the like. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

What is claimed is:

1. A network management system comprising:
memory; and
processing circuitry coupled to the memory, the processing circuitry configured to:
obtain an electrical parameter value associated with one or more circuit elements of an antenna connected to a device;
determine, based on the electrical parameter value, an identifier of the antenna;
determine, based on the identifier of the antenna, one or more operational parameters for the antenna; and
send the one or more operational parameters to the device to control operation of the antenna.

2. The network management system of claim 1, wherein to determine the identifier of the antenna, the processing circuitry is configured to determine the identifier of the antenna based on a lookup table including at least a mapping of the identifier of the antenna to the electrical parameter value.

3. The network management system of claim 1, wherein to determine the one or more operational parameters for the antenna, the processing circuitry is configured to determine the one or more operational parameters based on a lookup table including at least a mapping of the identifier of the antenna to the one or more operational parameters.

4. The network management system of claim 1, wherein the identifier of the antenna includes an antenna part number associated with the antenna.

5. The network management system of claim 1, wherein the antenna is a first antenna, the electrical parameter value is a first electrical parameter value, the identifier is a first identifier, and the one or more operational parameters is a first set of operational parameters, and wherein the processing circuitry is further configured to:
obtain a second electrical parameter value associated with a second antenna connected to the device;
determine, based on the second electrical parameter value, a second identifier of the second antenna;
determine, based on the second identifier, a second set of operational parameters for the antenna; and
send the second set of operational parameters to the device to control operation of the second antenna.

6. The network management system of claim 1, wherein the device is an access point.

7. The network management system of claim 1, wherein the one or more circuit elements comprise a resistor.

8. The network management system of claim 1, wherein the electrical parameter value comprises one or more of a resistor value, a current value, or an impedance value.

9. The network management system of claim 1, wherein the one or more operational parameters comprises one or more of an antenna gain, a transmission power limit, or beam width.

10. A network device comprising:
processing circuitry configured to:
determine an electrical parameter value associated with one or more circuit elements of an antenna connected to the network device;
send the electrical parameter value to a network management system;
receive, from the network management system and based on sending the electrical parameter value to the network management system, one or more operational parameters for the antenna; and
control an operation of the antenna based on the one or more operational parameters for the antenna.

11. The network device of claim 10, wherein to control the operation of the antenna, the processing circuitry is configured to set, based on the one or more operational parameters, configuration information associated with operation of the antenna.

12. The network device of claim 10,
wherein the network device further comprises a measurement circuit configured to measure the electrical parameter value associated with one or more circuit elements of the antenna, and
wherein to determine the electrical parameter value associated with one or more circuit elements of the antenna, the processing circuitry is configured to determine the electrical parameter value associated with one or more circuit elements of the antenna based on the electrical parameter value associated with one or more circuit elements of the antenna measured by the measurement circuit.

13. The network device of claim 12, wherein the measurement circuit is configured to measure the electrical parameter value associated with one or more circuit elements of the antenna in response to the antenna being connected to the device.

14. The network device of claim 10, wherein the processing circuitry is configured to:
determine an identifier of the antenna based on the electrical parameter value; and
send the identifier to the network management system.

15. The network device of claim 1, wherein the one or more operational parameters comprises one or more of an antenna gain, a transmission power limit, or beam width.

16. The network device of claim 10, wherein the one or more circuit elements comprise a resistor.

17. A system comprising:
a network management system; and
a device connected to an antenna, wherein the device is configured to:
determine an electrical parameter value associated with the antenna,
send the electrical parameter value to the network management system,
wherein the network management system is configured to:
determine, based on the electrical parameter value, an identifier of the antenna,
determine, based on the identifier of the antenna, one or more operational parameters for the antenna, and
send, to the device, the one or more operational parameter to control operation of the antenna, and
wherein the device is further configured to control an operation of the antenna based on the one or more operational parameters.

18. The system of claim 17, wherein the device further comprises a measurement circuit configured to measure the electrical parameter value associated with one or more circuit elements of the antenna, and
wherein to determine the electrical parameter value associated with one or more circuit elements of the antenna, the device is configured to determine the electrical parameter value associated with one or more circuit elements of the antenna based on the electrical parameter value associated with one or more circuit elements of the antenna measured by the measurement circuit.

19. The system of claim 17, wherein to determine the identifier of the antenna, the network management system is configured to determine the identifier of the antenna based on a lookup table including at least a mapping of the identifier of the antenna to the electrical parameter value.

20. The system of claim 17, wherein to determine the one or more operational parameters for the antenna, the network management system configured to determine the one or more operational parameters based on a lookup table including at least a mapping of the identifier of the antenna to the one or more operational parameters.
